(19) United States
(12) Patent Application Publication
(10) Pub. No.: US 2025/0157262 A1
(43) Pub. Date: May 15, 2025

(54) WARNING APPARATUS, WARNING METHOD, AND NON-TRANSITORY STORAGE MEDIUM

(71) Applicant: NEC Corporation, Minato-ku, Tokyo (JP)

(72) Inventors: Norihito OI, Tokyo (JP); Tooru IWAMOTO, Tokyo (JP); Takuroh KASHIMA, Tokyo (JP); Tomoaki MAKINO, Tokyo (JP)

(73) Assignee: NEC Corporation, Minato-ku, Tokyo (JP)

(21) Appl. No.: 18/727,119

(22) PCT Filed: Jan. 17, 2022
(86) PCT No.: PCT/JP2022/001318

§ 371 Date: Jul. 8, 2024

(51) Int. Cl. G07C 5/00; B60L 58/12

(52) U.S. Cl. CPC G07C 5/004; B60L 58/12

(57) ABSTRACT

The present invention provides a warning apparatus (10) including a prediction information acquisition unit (11) that acquires prediction information indicating a change in a predicted value of state of charge (SOC) of a vehicle while traveling based on a transport plan is performed, an actual measurement value acquisition unit (12) that acquires an actual measurement value of SOC of the vehicle while traveling based on the transport plan is performed, a determination unit (13) that determines whether a relationship between the predicted value and the actual measurement value satisfies a predetermined warning condition, and an output unit (14) that outputs first warning information in a case where the warning condition is satisfied.

### TECHNICAL FIELD The present invention relates to a warning apparatus, a warning method, and a program.

### BACKGROUND ART

A technique related to an electric vehicle is disclosed in each of Patent Documents 1 to 3.

Patent Document 1 discloses a technique for deriving a change in a predicted value of state of charge (SOC) up to a destination.

Patent Document 2 discloses a technique for determining a point where SOC tends to decrease, and notifying a user of an area including the determined point as an area where there is a possibility that running out of electricity in a battery occurs.

Patent Document 3 discloses a technique for notifying a user that there is a possibility that traveling becomes impossible due to an insufficient charge amount in a case where it is sensed that there is a change in the number of passengers, use/non-use of an air conditioner, and the like from an initial schedule while traveling.

### RELATED DOCUMENT

### Patent Document

Patent Document 1: Japanese Patent Application Publication No. 2003-111209
Patent Document 2: Japanese Patent Application Publication No. 2015-69259
Patent Document 3: Japanese Patent Application Publication No. 2010-32459

### DISCLOSURE OF THE INVENTION

### Technical Problem

By notifying a user of a possibility of running out of electricity at appropriate timing, running out of electricity in an electric vehicle can be effectively avoided. An example object of the present invention is to provide a new technique for notifying a user of a possibility of running out of electricity in an electric vehicle.

### Solution to Problem

The present invention provides a warning apparatus including:
a prediction information acquisition unit that acquires prediction information indicating a change in a predicted value of SOC of a vehicle while traveling based on a transport plan is performed;
an actual measurement value acquisition unit that acquires an actual measurement value of SOC of the vehicle while traveling based on the transport plan is performed;
a determination unit that determines whether a relationship between the predicted value and the actual measurement value satisfies a predetermined warning condition; and
an output unit that outputs first warning information in a case where the warning condition is satisfied.

Moreover, the present invention provides a warning method of executing,
by a computer:
   a prediction information acquisition step of acquiring prediction information indicating a change in a predicted value of SOC of a vehicle while traveling based on a transport plan is performed;
   an actual measurement value acquisition step of acquiring an actual measurement value of SOC of the vehicle while traveling based on the transport plan is performed;
   a determination step of determining whether a relationship between the predicted value and the actual measurement value satisfies a predetermined warning condition; and
   an output step of outputting first warning information in a case where the warning condition is satisfied.

Moreover, the present invention provides a program causing a computer to function as:
a prediction information acquisition unit that acquires prediction information indicating a change in a predicted value of SOC of a vehicle while traveling based on a transport plan is performed;
an actual measurement value acquisition unit that acquires an actual measurement value of SOC of the vehicle while traveling based on the transport plan is performed;
a determination unit that determines whether a relationship between the predicted value and the actual measurement value satisfies a predetermined warning condition; and
an output unit that outputs first warning information in a case where the warning condition is satisfied.

### Advantageous Effects of Invention

According to the present invention, a new technique for notifying a user of a possibility of running out of electricity in an electric vehicle is achieved.

### BRIEF DESCRIPTION OF THE DRAWINGS

FIG. 1 It is a diagram illustrating one example of a hardware configuration of a warning apparatus.

FIG. 2 It is one example of a functional block diagram of the warning apparatus.

FIG. 3 It is a diagram schematically illustrating one example of prediction information.

FIG. 4 It is a diagram schematically illustrating one example of prediction information.

FIG. 5 It is a diagram schematically illustrating one example of a transport plan.

FIG. 6 It is a diagram schematically illustrating one example of a transport plan.

FIG. 7 It is a diagram schematically illustrating one example of a transport plan.

FIG. 8 It is a diagram schematically illustrating one example of a transport plan.

FIG. 9 It is a flowchart illustrating one example of a flow of processing of the warning apparatus.

FIG. 10 It is a diagram for describing processing performed by the warning apparatus.

### DESCRIPTION OF EMBODIMENTS

Hereinafter, example embodiments of the present invention are described by use of the drawings. Note that, a similar reference sign is assigned to a similar component in all the drawings, and description is omitted as appropriate. Note that, an “electric vehicle” powered by electricity is hereinafter simply referred to as a “vehicle”. In other words, the “vehicle” referred to below is an “electric vehicle”. Moreover, “transport” in the present specification is a concept including both delivering a package to a transport destination and collecting a package at the transport destination.

### First Example Embodiment

### “Outline”

A warning apparatus according to the present example embodiment is utilized in a vehicle for transport that departs from a base, then visits a plurality of transport destinations, and, thereafter, returns to the base. The vehicle performs traveling based on a previously produced transport plan. The transport plan determines a transport destination, a transport order, and the like in such a way that running out of electricity does not occur halfway. Moreover, the transport plan may determine that charging is performed before departure from a base or halfway.

As described above, a transport plan is determined in such a way that running out of electricity does not occur halfway. However, there is a case where a change in a predicted value of SOC while traveling based on the transport plan is performed does not match a change in an actual measurement value of SOC while traveling based on the transport plan is actually performed. Moreover, there can also be a case where, although the transport plan determines that charging is performed before departure from a base or halfway, charging is not performed as determined. As a result, there is a possibility that running out of electricity occurs halfway although a transport plan is determined in such a way that running out of electricity does not occur halfway.

Accordingly, the warning apparatus acquires “prediction information indicating a change in a predicted value of SOC of a vehicle while traveling based on a transport plan is performed”, and also acquires “an actual measurement value of SOC of the vehicle while traveling based on the transport plan is performed”. Then, the warning apparatus determines whether a relationship (e.g., deviation status) between the predicted value and the actual measurement value satisfies a predetermined warning condition, and outputs first warning information in a case where the warning condition is satisfied.

In this way, the warning apparatus detects a possibility of running out of electricity of a vehicle, based on a relationship (e.g., deviation status) between a predicted value of SOC of the vehicle while traveling based on a transport plan determined in such a way that running out of electricity does not occur halfway is performed, and an actual measurement value of SOC of the vehicle while traveling based on the transport plan is performed.

### “Hardware Configuration”

Next, one example of a hardware configuration of a warning apparatus is described. Each functional unit of the warning apparatus is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a storage medium such as a compact disc (CD) or a server or the like on the Internet), and an interface for network connection. Then, it is appreciated by a person skilled in the art that there are a variety of modified examples of a method and an apparatus for the achievement.

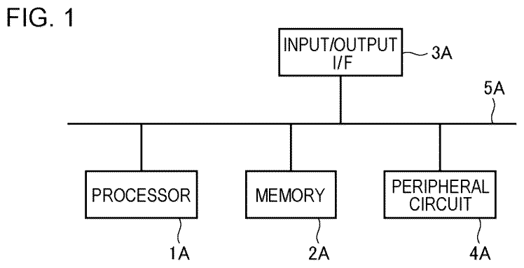

FIG. 1 is a block diagram illustrating a hardware configuration of the warning apparatus. As illustrated in FIG. 1, the warning apparatus includes a processor 1A, a memory 2A, an input/output interface 3A, a peripheral circuit 4A, and a bus 5A. The peripheral circuit 4A includes various modules. The warning apparatus may not include the peripheral circuit 4A. Note that, the warning apparatus may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### “Function Configuration”

Next, the functional configuration of the warning apparatus is described.

The warning apparatus may be, for example, an in-vehicle apparatus. Then, the warning apparatus may output warning information to a driver of a vehicle.

Otherwise, the warning apparatus may be a server that communicates with the in-vehicle apparatus. Then, the warning apparatus may acquire various pieces of information (an actual measurement value of SOC, and the like) relating to the vehicle via the in-vehicle apparatus, and output warning information to the driver of the vehicle via the in-vehicle apparatus.

Otherwise, the warning apparatus may be a server that communicates with the in-vehicle apparatus. Then, the warning apparatus may acquire various pieces of information (an actual measurement value of SOC, and the like) relating to the vehicle via the in-vehicle apparatus, and output warning information to a monitoring person via the monitoring person apparatus operated by the monitoring person who monitors a plurality of vehicles.

Otherwise, the warning apparatus may be a server that communicates with the in-vehicle apparatus. Then, the warning apparatus may acquire various pieces of information (an actual measurement value of SOC, and the like) relating to the vehicle via the in-vehicle apparatus. Moreover, the warning apparatus may output warning information to a driver of a vehicle via the in-vehicle apparatus, and output warning information to a monitoring person via the monitoring person apparatus operated by the monitoring person who monitors a plurality of vehicles.

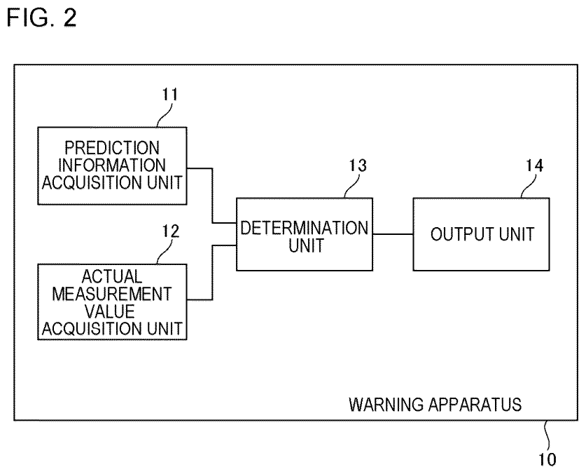

FIG. 2 illustrates one example of a functional block diagram of a warning apparatus 10. As illustrated, the warning apparatus 10 includes a prediction information acquisition unit 11, an actual measurement value acquisition unit 12, a determination unit 13, and an output unit 14.

The prediction information acquisition unit 11 acquires prediction information indicating a change in a predicted value of SOC of a vehicle while traveling based on a transport plan is performed. The prediction information acquisition unit 11 may acquire prediction information by accepting an input of the prediction information. Otherwise, the prediction information acquisition unit 11 may produce prediction information based on a transport plan. Processing of producing prediction information based on a transport plan is described in the following example embodiments.

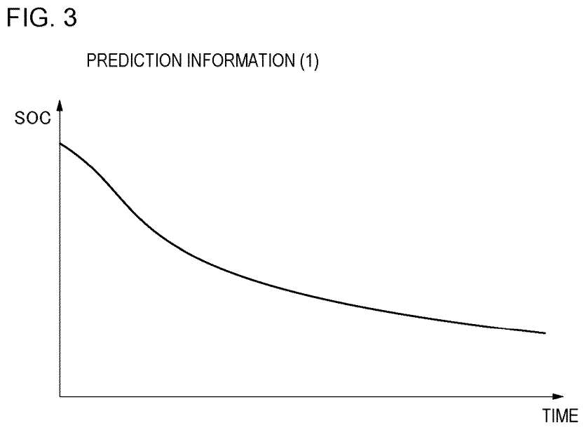

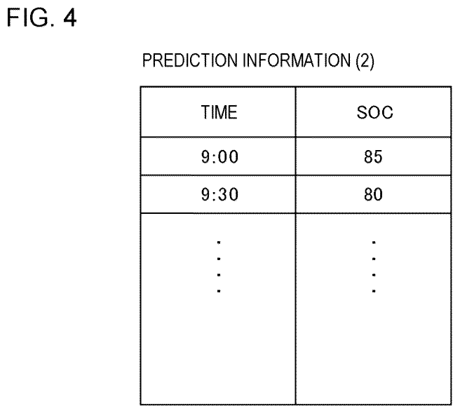

FIG. 3 illustrates one example of prediction information. The prediction information illustrated in the figure indicates a predicted value of SOC at any timing from departure from a base to return to the base. FIG. 4 illustrates another example of prediction information. The prediction information illustrated in the figure indicates a predicted value of SOC at a predetermined timing from departure from a base to return to the base. For example, a predicted value of SOC every 30 minutes may be indicated as illustrated in the figure, or a time interval may be different from the illustrated example. Moreover, the time interval may be shortened as a predicted value of SOC becomes smaller.

Next, a transport plan is described. The transport plan indicates a transport destination, a transport order, a weight of a package, and the like. Moreover, the transport plan may indicate that charging is performed before departure from a base or halfway.

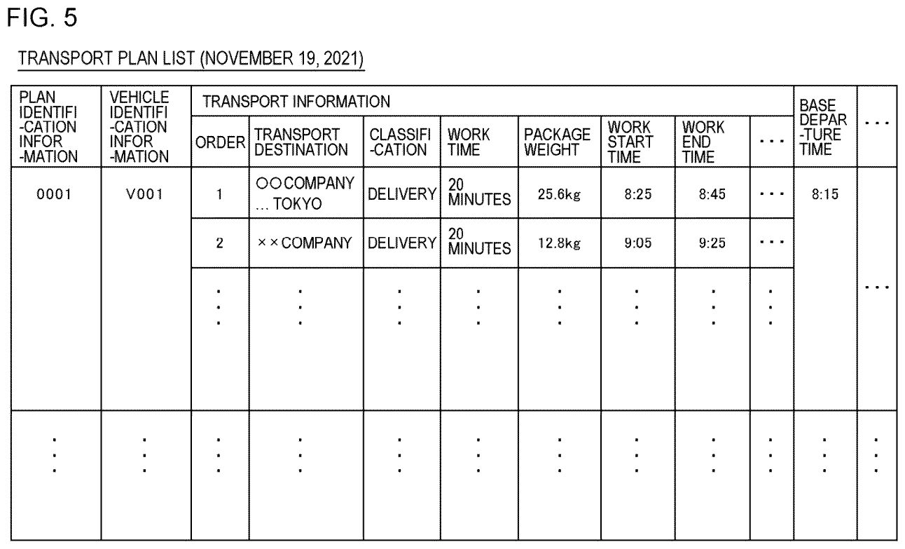

FIG. 5 schematically illustrates one example of a transport plan. In FIG. 5, a plurality of delivery plans for Nov. 19, 2021 are listed. In FIG. 5, plan identification information, vehicle identification information, transport information, and a base departure time are associated with each other. Note that, the transport plan may include other pieces of information.

“Plan identification information” is information for mutually identifying a plurality of transport plans.

“Vehicle identification information” is information for mutually identifying a plurality of vehicles utilized for transport. Each piece of plan identification information is associated with vehicle identification information of a vehicle allocated to each transport plan.

“Transport information” includes an order, a transport destination, a classification, a work time, a package weight, a work start time, and a work end time.

“Order” indicates a transport order.

“Transport destination” indicates a name and an address of a party to whom a package is to be delivered or a party from whom a package is to be collected.

“Classification” indicates a type of work, i.e. delivery or collection.

“Work time” indicates a time required for work (delivery/collection) to be performed at a transport destination.

“Package weight” indicates a weight of a package to be delivered to a delivery destination or a package to be collected at a collection destination.

“Work start time” indicates a time at which work (delivery/collection) starts at a transport destination.

“Work end time” indicates a time at which work (delivery/collection) ends at a transport destination.

“Base departure time” indicates a time at which a vehicle departs from a base such as an office. The vehicle departs from a base, then visits a plurality of transport destinations, and, thereafter, returns to the base. A base to depart from and a base to return to may be the same or different.

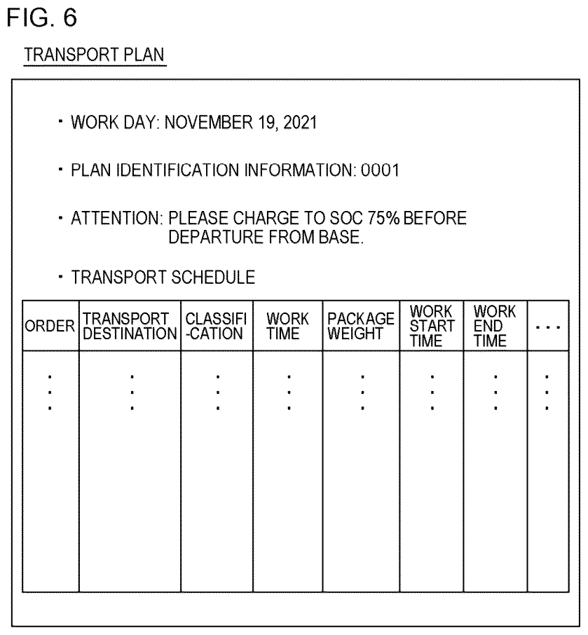

FIG. 6 schematically illustrates another example of a transport plan. In FIG. 6, one delivery plan (plan identification information: 0001) for Nov. 19, 2021 is displayed. In FIG. 6, a work day, plan identification information, a matter requiring attention, and a transport schedule are displayed. The work date, the plan identification information, and the transport schedule have the same contents as those in the transport plan in FIG. 5. The matter requiring attention indicates performing charging before departure from a base, and a charge amount. In other words, the transport plan is a transport plan in which charging before departure from a base is added to the transport plan in FIG. 5.

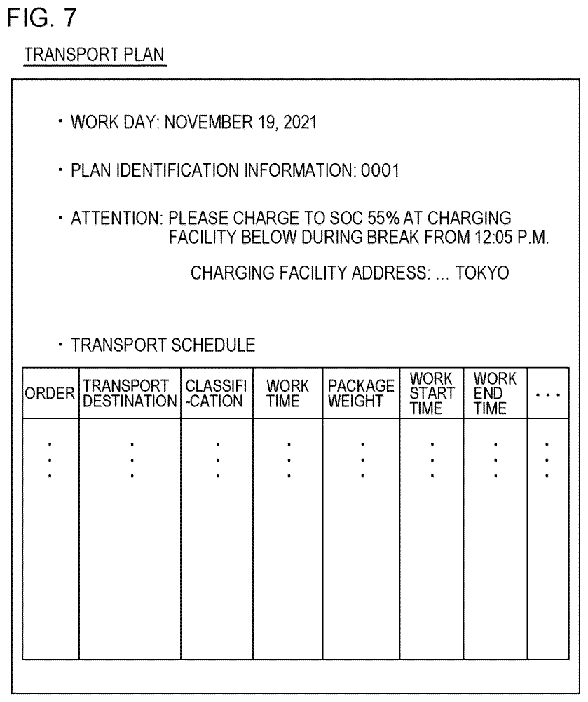

FIG. 7 schematically illustrates another example of a transport plan. In FIG. 7, one delivery plan (plan identification information: 0001) for Nov. 19, 2021 is displayed. In FIG. 7, a work day, plan identification information, a matter requiring attention, and a transport schedule are displayed. The work date, the plan identification information, and the transport schedule have the same contents as those in the transport plan in FIG. 5. The matter requiring attention indicates performing charging before a break, and a charge amount. In other words, the transport plan is a transport plan in which charging during a break is added to the transport plan in FIG. 5.

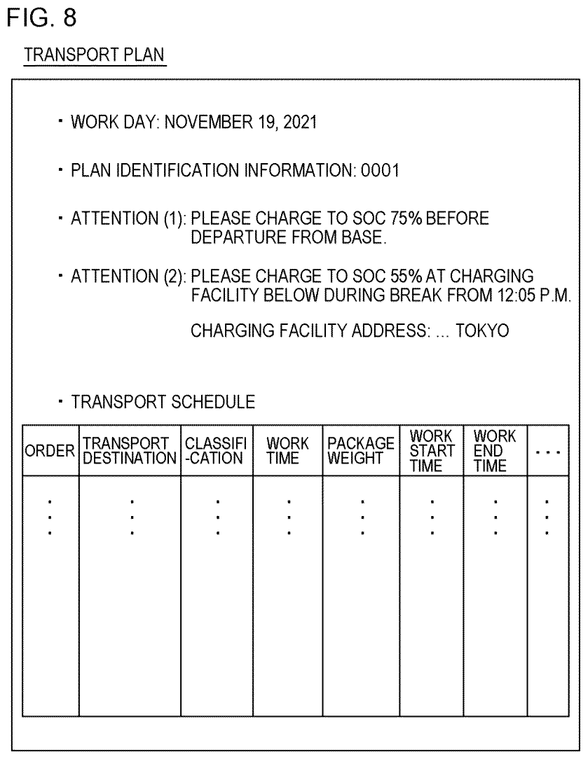

FIG. 8 schematically illustrates another example of a transport plan. In FIG. 8, one delivery plan (plan identification information: 0001) for Nov. 19, 2021 is displayed. In FIG. 8, a work day, plan identification information, a matter requiring attention, and a transport schedule are displayed. The work date, the plan identification information, and the transport schedule have the same contents as those in the transport plan in FIG. 5. The matter requiring attention indicates performing charging before departure from a base, an amount of the charging, performing charging during a break, and an amount of the charging. In other words, the transport plan is a transport plan in which charging before departure from a base and during a break is added to the transport plan in FIG. 5.

Such a transport plan is produced by utilizing any technique. For example, a transport plan may be produced by use of a technique described in Non-Patent Document 1.

Returning to FIG. 2, the actual measurement value acquisition unit 12 acquires an actual measurement value of SOC of the vehicle while traveling based on the transport plan is performed. The actual measurement value acquisition unit 12 acquires an actual measurement value of SOC of the vehicle detected by a well-known technique.

The determination unit 13 determines whether a relationship between a predicted value of SOC of the vehicle at a certain moment indicated by the prediction information and the actual measurement value of SOC of the vehicle at the moment satisfies a predetermined warning condition. The warning condition relates to deviation status between the predicted value and the actual measurement value. A specific example of a warning condition is described in the following example embodiments.

The output unit 14 outputs first warning information in a case where the warning condition is satisfied. The first warning information indicates that there is a possibility that running out of electricity occurs while traveling based on the transport plan is performed. The output unit 14 can output the first warning information via any output apparatus such as a display, a speaker, a projection apparatus, a warning lamp, or the like.

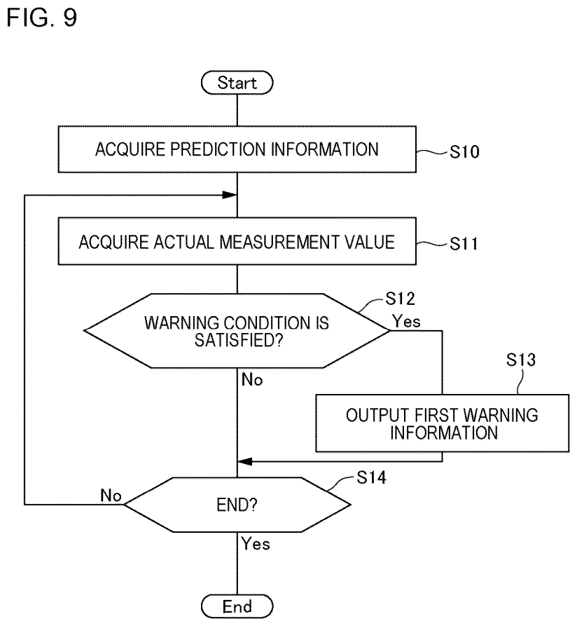

Next, one example of a flow of processing of the warning apparatus 10 is described by use of a flowchart in FIG. 9.

First, the warning apparatus 10 acquires prediction information indicating a change in a predicted value of SOC of a vehicle while traveling based on a transport plan is performed (S10). Moreover, the warning apparatus 10 acquires an actual measurement value of SOC of the vehicle while traveling based on the transport plan is performed (S11). Then, the warning apparatus 10 determines whether a relationship between the actual measurement value at a current point acquired in S11 and the predicted value at a current point indicated by the prediction information acquired in S10 satisfies a predetermined warning condition (S12).

In a case where the warning condition is satisfied (Yes in S12), the warning apparatus 10 outputs the first warning information (S13). In a case where the warning condition is not satisfied (No in S12), the warning apparatus 10 does not output the first warning information.

### Advantageous Effect

The warning apparatus 10 according to the present example embodiment outputs first warning information indicating that there is a possibility that running out of electricity is caused while traveling based on a transport plan is performed, in a case where a relationship between a predicted value of SOC of a vehicle while traveling based on a transport plan produced in such a way that running out of electricity does not occur halfway is performed, and an actual measurement value of SOC of the vehicle satisfies a predetermined warning condition. In a case of this method, the first warning information is output based on a relationship between a predicted value of SOC and an actual measurement value of SOC regardless of magnitude of a current actual measurement value of SOC. In this case, the first warning information can be output under status where a current actual measurement value of SOC is relatively great (example: 60%, 70%, or the like). In this way, by outputting the first warning information under status where a current actual measurement value of SOC is relatively great (example: 60%, 70%, or the like), it becomes possible to sufficiently ensure a preparation time for charging.

Moreover, warning with high reliability can be performed by outputting first warning information based on a relationship between a predicted value of SOC of a vehicle while traveling based on a transport plan produced in such a way that running out of electricity does not occur halfway is performed, and an actual measurement value of SOC of the vehicle.

### Second Example Embodiment

In the present example embodiment, a warning condition is embodied. The warning conditions include at least one of first to fourth warning conditions The warning conditions may further include a fifth warning condition below. below.

### First Warning Condition

The first warning condition is that “an actual measurement value of SOC of a vehicle at a moment of departing from a base is less than a predicted value of SOC of the vehicle at the moment”. A purpose of warning based on the first warning condition is that, in a case where, at a moment of departing from a base, an actual measurement value of SOC of a vehicle is already lower than a predicted value of SOC of the vehicle at the moment, there is a possibility that running out of electricity is caused halfway, and, therefore, warning is performed. According to such a first warning condition, the first warning information indicating that there is a possibility that running out of electricity is caused while traveling based on a transport plan is performed can be output at a base departure moment.

### Second Warning Condition

The second warning condition is that “an actual measurement value of SOC of a vehicle at a moment of departing from a base is less than a predicted value of SOC of the vehicle at the moment, and a deviation level between the actual measurement value and the predicted value is equal to or more than a first threshold value”. The deviation level is indicated by, for example, a difference between a predicted value and an actual measurement value. The first threshold value is a previously determined value, and a specific value thereof is a matter of design. A purpose of warning based on the second warning condition is that, in a case where, at a moment of departing from the base, an actual measurement value of SOC of a vehicle is already lower than a predicted value of SOC of the vehicle at the moment, and a deviation level therebetween is relatively great, a possibility that running out of electricity is caused halfway is great, and, therefore, warning is performed.

According to such a second warning condition, the first warning information indicating that there is a possibility that running out of electricity is caused while traveling based on a transport plan is performed can be output at a base departure moment.

### Third Warning Condition

The third warning condition is that “an actual measurement value of SOC of a vehicle at a moment after departing from a base is less than a predicted value of SOC of the vehicle at the moment, and a deviation level between the actual measurement value and the predicted value is equal to or more than a second threshold value”. The deviation level is indicated by, for example, a difference between a predicted value and an actual measurement value.

The second threshold value is a previously determined value, and a specific value thereof is a matter of design. A purpose of warning based on the third warning condition is that, in a case where, at a moment after departing from a base, an actual measurement value of SOC of a vehicle is lower than a predicted value of SOC of the vehicle at the moment, and the deviation level becomes great to a degree that there is a possibility that running out of electricity occurs halfway, warning is performed. The second threshold value may be a value greater than the first threshold value.

Otherwise, the second threshold value may be a value that changes according to progress status of work based on a transport plan. In this case, a value of the second threshold value becomes great as the work based on the transport plan progresses. For example, the second threshold value may change according to time. In this case, the second threshold value becomes smaller as it is closer to a time at base departure, and the second threshold value becomes greater as it is closer to a time of returning to the base.

### Fourth Warning Condition

The fourth warning condition is that “an actual measurement value of SOC of a vehicle at a moment after departing from a base is less than a predicted value of SOC of the vehicle at the moment, a deviation level between the actual measurement value and the predicted value is equal to or more than a third threshold value and less than a fourth threshold value, and there is no charging facility at and after the criterion point in a traveling route based on a transport plan”. The deviation level is indicated by, for example, a difference between a predicted value and an actual measurement value.

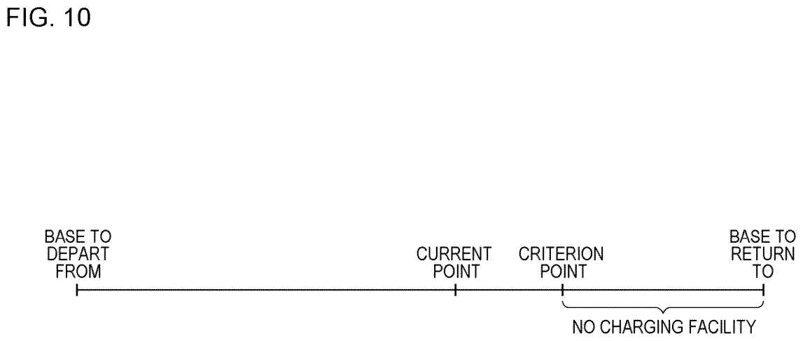

A purpose of warning based on the fourth warning condition is that the actual measurement value is not so much far from a predicted value as to satisfy the third warning condition, but the actual measurement value is far from the predicted value to some extent, and, since there is no charging facility at and after the criterion point, early charging (before reaching the criterion point) is encouraged. As illustrated in FIG. 10, in a case where the first warning information can be output before reaching the criterion point, it becomes possible to perform charging between a current point and the criterion point.

The third threshold value is a previously determined value, and a specific value thereof is a matter of design. The third threshold value is a value smaller than the second threshold value.

Otherwise, the third threshold value may be a value that changes according to progress status of work based on a transport plan. In this case, a value of the third threshold value becomes great as the work based on the transport plan progresses. For example, the third threshold value may change according to time. In this case, the third threshold value becomes smaller as it is closer to a time at base departure, and the third threshold value becomes greater as it is closer to a time of returning to the base.

The fourth threshold value is a value greater than the third threshold value. The fourth threshold value may be the same value as the second threshold value, or may be a value smaller than the second threshold value.

Next, a criterion point is described. There is a case where a driver prioritizes delivery and collection, and postpones charging. As a result, a disadvantage that no charging facility exists in a route after a moment at which charging is intended may occur. By appropriately setting a criterion point, occurrence of a disadvantage that may be caused in such a case where charging is postponed can be suppressed. A criterion point is, for example, a transport destination (e.g., the last transport destination) in a predetermined visiting order among a plurality of transport destinations, a point where a vehicle is predicted to be located at a criterion time, or a point where a predicted value of SOC of a vehicle based on prediction information is predicted to be a criterion value.

Next, “there is no charging facility at and after a criterion point in a traveling route based on a transport plan” is described. The condition may be, for example, “there is no charging facility on a traveling route at and after a criterion point in the traveling route based on a transport plan”. Otherwise, the condition is, for example, “there is no charging facility within a predetermined distance from each point on a traveling route at and after a criterion point in the traveling route based on a transport plan, and on a traveling route at and after the criterion point”.

Note that, charging facilities can be classified into a public one and a private one. A reservation for charging cannot be made at a public charging facility. Thus, it is not known whether a charging facility can be utilized until going to the charging facility. On the other hand, in some charging facilities of use, a reservation for charging can be made, and reservation status can be inquired about. Further, there exist some charging facilities that cannot be utilized by some vehicles such as a large vehicle due to a parking space, a road width up to the parking space, and the like. Accordingly, the driver may be notified which type of charging facility is not present at and after a criterion point in a traveling route based on a transport plan.

Moreover, in a case where determining that there is a charging facility at and after a criterion point in a traveling route based on a transport plan, the warning apparatus 10 may notify a driver which type of charging facility is present. Moreover, in a case where reservation status can be inquired about, the warning apparatus 10 may further notify the driver of reservation status. On the other hand, in a case where reservation status cannot be inquired about, the warning apparatus 10 may notify the driver of a congestion degree (prediction from a past congestion degree on the same day of a week and at the same time, or the like) predicted based on a past actual result. Note that, a means with which the warning apparatus 10 determines which type each charging facility is is not particularly limited, and any configuration can be adopted. For example, a database in which a type of each of a plurality of charging facilities is registered may be previously produced. Then, the warning apparatus 10 may refer to the database, and determine which type each charging facility is.

### Fifth Warning Condition

The fifth warning condition is that “an electric power amount required in a case where moving from a current point to a predetermined point is less than a remaining electric power amount indicated by an actual measurement value of SOC of a vehicle at the moment”. The fifth warning condition is not based on a relationship between a predicted value of SOC of a vehicle and an actual measurement value of SOC of the vehicle. However, a warning condition may include such a fifth warning condition.

A predetermined point is a base to depart from, a base to return to, another related office, or the like. There may be one predetermined point or a plurality of predetermined points. Information (an address, latitude and longitude, and the like) indicating a predetermined point is previously registered in the warning apparatus 10.

The output unit 14 outputs the first warning information in a case where the warning condition as described above is satisfied. Note that, in a case where a warning condition includes a plurality of ones among the first to fifth warning conditions, the output unit 14 outputs the first warning information in a case where one of the plurality of warning conditions is satisfied. In this case, the output unit 14 may change a content of the first warning information to be output, according to a type of a warning condition that is satisfied.

Otherwise, the output unit 14 may output second warning information in a case where an actual measurement value of SOC of a vehicle becomes lower than a fifth threshold value. The fifth threshold value is a previously determined value, for example, 30%, 15%, 10%, or the like. Thereby, the second warning information can be output at a moment at which the actual measurement value of SOC of the vehicle becomes small to some extent. The second warning information indicates that SOC of the vehicle has become small, and charging is needed. The output unit 14 can output the second warning information via any output apparatus such as a display, a speaker, a projection apparatus, a warning lamp, or the like.

Then, the output unit 14 outputs the first warning information in a case where an actual measurement value of SOC of a vehicle is not lower than the fifth threshold value but the warning condition described above is satisfied. As a result, the first warning information can be output at a moment at which the actual measurement value of SOC of the vehicle is not so small.

Other components of the warning apparatus 10 according to the present example embodiment are similar to those according to the first example embodiment.

The warning apparatus 10 according to the present example embodiment achieves an advantageous effect similar to that according to the first example embodiment. Moreover, the warning apparatus 10 according to the present example embodiment can notify a user that there is a possibility that running out of electricity is caused while traveling based on a transport plan is performed, at a preferable timing, by performing warning, based on a characteristic warning condition.

### Third Example Embodiment

In the present example embodiment, processing of producing prediction information based on a transport plan is embodied.

A prediction information acquisition unit 11 acquires SOC of a vehicle at base departure. Then, the prediction information acquisition unit 11 produces prediction information, based on SOC of the vehicle at base departure, and a transport plan. Each piece of processing is described below.

### Processing of Acquiring SOC of a Vehicle at Base Departure

### First Example

For example, a user may input SOC of a vehicle at base departure to a warning apparatus 10. Then, the prediction information acquisition unit 11 may acquire SOC of a vehicle at base departure input by the user. For example, the user visually recognizes information displayed by an in-vehicle apparatus or the like installed in the vehicle at any timing after business of a previous day is finished and until base departure on a current day, and thereby confirms SOC of the vehicle at the moment. Then, the user inputs confirmed SOC of the vehicle to the warning apparatus 10 as SOC of the vehicle at base departure.

### Second Example

Otherwise, the prediction information acquisition unit 11 may communicate with an apparatus that manages SOC of a vehicle, and acquire SOC of the vehicle from the apparatus. For example, at any timing after business of a previous day is finished and until base departure on a current day, the prediction information acquisition unit 11 acquires SOC of the vehicle at the moment from the apparatus as SOC of the vehicle at base departure.

### Third Example

Otherwise, the prediction information acquisition unit 11 may acquire reservation information indicating reservation status of a charging facility. The reservation information indicates a reservation time (reservation start time and reservation end time), and the vehicle identification information of the vehicle to be charged at the reservation time.

Then, after acquiring SOC (hereinafter, “first SOC”) of the vehicle at base departure by the method of the first example or the second example, the prediction information acquisition unit 11 computes, regarding a vehicle for which a reservation for a charging facility has been made at and after the acquisition and before departure from the base, SOC acquired by adding a charge amount to be charged by the reservation to the first SOC, as SOC of the vehicle at base departure. A charge amount to be charged by a reservation can be a smaller one of a product of a time from a reservation start time to a reservation end time and a charging velocity of a charging facility, and a free capacity of the vehicle (100%−capacity for (first SOC)).

### Processing of Producing Prediction Information, Based on SOC of a Vehicle at Base Departure and a Transport Plan

The prediction information acquisition unit 11 divides a part from a base to depart from to a base to return to into a plurality of sections. Specifically, the prediction information acquisition unit 11 defines, as one section, each of “a part from the base to depart from to a first transport destination”, “a part from the first transport destination to a second transport destination”, “a part from the second transport destination to a third transport destination”, . . . , “a part from a last transport destination to the base to return to”.

Then, for each section, the prediction information acquisition unit 11 computes a change in SOC in consideration of load capacity for each section, SOC at start of each section (synonymous with SOC at end of an immediately preceding section), and the like, and links the results in chronological order, and thereby predicts a change in SOC of a vehicle from a base to depart from to a base to return to. A method of predicting a change in SOC in consideration of load capacity is not particularly limited, and any technique can be adopted. For example, machine learning or another existing technique may be utilized. One example is described below, but it is not limited thereto.

For example, the prediction information acquisition unit 11 determines electricity consumption (km/kWh) of a vehicle for each section. Electricity consumption is determined in consideration of load capacity for each section, information relating to a route passed in each section (pavement status of a road, predicted congestion status of a road, inclination status of a road, a curvature radius of a curve existing in a route, the number of right and left turns existing in a route, and the like), a weather condition for a current day (weather, temperature, humidity, wind speed, and the like), a vehicle type, air resistance according to a vehicle type, power consumption due to mounting, and the like. Information relating to a route passed in each section is determined based on previously prepared map data. The map data indicate pavement status at each position, general congestion status, inclination status, a curvature radius of a curve, and the like.

For each condition generated by connecting these items with a logical operator, a reference table in which electricity consumption in a case where the condition is satisfied is registered may be previously registered in a storage unit of the warning apparatus 10. Then, the prediction information acquisition unit 11 may search for a condition that each section satisfies, and determine electricity consumption for each section. The condition is, for example, “load capacity: equal to or more than X1 [kg], weather: sunny, temperature: equal to or more than 15° C. and equal to or less than 25° C., and . . . ”.

Otherwise, an arithmetic expression for computing electricity consumption by inputting a value of the item described above may be previously generated, and registered in the storage unit of the warning apparatus 10. Then, the prediction information acquisition unit 11 may input the value of the item described above to the arithmetic expression for each section to determine electricity consumption for each section.

Otherwise, a learning model may be generated that estimates electricity consumption from a combination of a plurality of types of the items described above by machine learning based on training data associating a combination of a plurality of types of the items described above with electricity consumption in a case where a plurality of types of items described above take the values. Then, the prediction information acquisition unit 11 may input the value of the item described above to the learning model for each section, and determine electricity consumption for each section.

Then, the prediction information acquisition unit 11 assumes that electric power is consumed in each section with electricity consumption for each section, and computes a change in SOC of the vehicle during transport, i.e., a change in SOC of the vehicle from a base to depart from to a base to return to.

### Method of Determining Load Capacity During Transport

As illustrated in FIG. 5, a transport plan indicates an order of transport, and a weight of a package to be transported at each transport destination. By use of the information, the load during transport can be determined.

First, by adding up package weights being relevant to the classification “delivery” in FIG. 5, a load capacity (hereinafter, “load capacity at departure”) from the base to depart from to the first transport destination can be computed.

Then, in a case where a classification of the first transport destination is “delivery”, a load capacity from the first transport destination to the second transport destination can be computed by subtracting, from the load capacity at departure, a weight of a package to be delivered at the first transport destination.

On the other hand, in a case where a classification of the first transport destination is “collection”, a load capacity from the first transport destination to the second transport destination can be computed by adding a weight of a package to be collected at the first transport destination to the load capacity at departure.

Subsequently, a load capacity from a certain transport destination to a next transport destination, and a load capacity from a last transport destination to a base to return to can be similarly computed.

Other components of the warning apparatus 10 according to the present example embodiment are similar to those according to the first example embodiment.

The warning apparatus 10 according to the present example embodiment achieves an advantageous effect similar to that according to the first and second example embodiments.

The example embodiments of the present invention have been described above with reference to the drawings, but are exemplifications of the present invention, and various configurations other than those described above can be adopted. The components according to the example embodiments described above may be combined with each other, or some components may be replaced with other components. Moreover, various modifications may be made to the configuration according to the example embodiment described above without departing from the scope of the present embodiment. Moreover, the configurations and pieces of processing disclosed in each of the example embodiments and modified examples described above may be combined with each other.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.
1. A warning apparatus including:
   a prediction information acquisition unit that acquires prediction information indicating a change in a predicted value of SOC of a vehicle while traveling based on a transport plan is performed;
   an actual measurement value acquisition unit that acquires an actual measurement value of SOC of the vehicle while traveling based on the transport plan is performed;
   a determination unit that determines whether a relationship between the predicted value and the actual measurement value satisfies a predetermined warning condition; and
   an output unit that outputs first warning information in a case where the warning condition is satisfied.
2. The warning apparatus according to supplementary note 1, wherein
   the warning condition includes a matter that the actual measurement value at a moment of departing from a base is less than the predicted value at the moment.
3. The warning apparatus according to supplementary note 1, wherein
   the warning condition includes a matter that the actual measurement value at a moment of departing from a base is less than the predicted value at the moment, and a deviation level between the actual measurement value and the predicted value is equal to or more than a first threshold value.
4. The warning apparatus according to any one of supplementary notes 1 to 3, wherein
   the warning condition includes a matter that the actual measurement value at a moment after departing from a base is less than the predicted value at the moment, and a deviation level between the actual measurement value and the predicted value is equal to or more than a second threshold value.
5. The warning apparatus according to any one of supplementary notes 1 to 4, wherein
   the warning condition includes a matter that the actual measurement value at a moment after departing from a base is less than the predicted value at the moment, a deviation level between the actual measurement value and the predicted value is equal to or more than a third threshold value and less than a fourth threshold value, and there is no charging facility at and after a criterion point in a traveling route based on the transport plan.
6. The warning apparatus according to supplementary note 5, wherein
   the criterion point is a transport destination in a predetermined visiting order among a plurality of transport destinations, a point where the vehicle is predicted to be located at a criterion time, or a point where the predicted value is predicted to be a criterion value.
7. The warning apparatus according to any one of supplementary notes 1 to 6, wherein
   the warning condition includes a matter that an electric power amount required while moving from a current point to a predetermined point is less than a remaining electric power amount indicated by the actual measurement value at the moment.
8. The warning apparatus according to any one of supplementary notes 1 to 7, wherein
   the output unit
      outputs second warning information in a case where the actual measurement value becomes lower than a fifth threshold value, and
      outputs the first warning information in a case where the actual measurement value is not lower than the fifth threshold value but the warning condition is satisfied.
9. A warning method of executing,
   by a computer:
      a prediction information acquisition step of acquiring prediction information indicating a change in a predicted value of SOC of a vehicle while traveling based on a transport plan is performed;
      an actual measurement value acquisition step of acquiring an actual measurement value of SOC of the vehicle while traveling based on the transport plan is performed;
      a determination step of determining whether a relationship between the predicted value and the actual measurement value satisfies a predetermined warning condition; and
      an output step of outputting first warning information in a case where the warning condition is satisfied.
10. A program causing a computer to function as:
   a prediction information acquisition unit that acquires prediction information indicating a change in a predicted value of SOC of a vehicle while traveling based on a transport plan is performed;
   an actual measurement value acquisition unit that acquires an actual measurement value of SOC of the vehicle while traveling based on the transport plan is performed;
   a determination unit that determines whether a relationship between the predicted value and the actual measurement value satisfies a predetermined warning condition; and
   an output unit that outputs first warning information in a case where the warning condition is satisfied.

### REFERENCE SIGNS LIST

10 Warning apparatus
11 Prediction information acquisition unit
12 Actual measurement value acquisition unit
13 Determination unit
14 Output unit
1A Processor
2A Memory
3A Input/output I/F
4A Peripheral circuit
5A Bus

What is claimed is:

1. A warning apparatus comprising:
at least one memory configured to store one or more instructions; and
at least one processor configured to execute the one or more instructions to:
acquire prediction information indicating a change in a predicted value of state of charge (SOC) of a vehicle while traveling based on a transport plan is performed;
acquire an actual measurement value of SOC of the vehicle while traveling based on the transport plan is performed;
determine whether a relationship between the predicted value and the actual measurement value satisfies a predetermined warning condition; and
output first warning information in a case where the warning condition is satisfied.

2. The warning apparatus according to claim 1, wherein
the warning condition includes a matter that the actual measurement value at a moment of departing from a base is less than the predicted value at the moment.

3. The warning apparatus according to claim 1, wherein
the warning condition includes a matter that the actual measurement value at a moment of departing from a base is less than the predicted value at the moment, and a deviation level between the actual measurement value and the predicted value is equal to or more than a first threshold value.

4. The warning apparatus according to claim 1, wherein
the warning condition includes a matter that the actual measurement value at a moment after departing from a base is less than the predicted value at the moment, and a deviation level between the actual measurement value and the predicted value is equal to or more than a second threshold value.

5. The warning apparatus according to claim 1, wherein
the warning condition includes a matter that the actual measurement value at a moment after departing from a base is less than the predicted value at the moment, a deviation level between the actual measurement value and the predicted value is equal to or more than a third threshold value and less than a fourth threshold value, and there is no charging facility at and after a criterion point in a traveling route based on the transport plan.

6. The warning apparatus according to claim 5, wherein
the criterion point is a transport destination in a predetermined visiting order among a plurality of transport destinations, a point where the vehicle is predicted to be located at a criterion time, or a point where the predicted value is predicted to be a criterion value.

7. The warning apparatus according to claim 1, wherein
the warning condition includes a matter that an electric power amount required while moving from a current point to a predetermined point is less than a remaining electric power amount indicated by the actual measurement value at the moment.

8. The warning apparatus according to claim 1, wherein
the at least one processor is further configured to execute the one or more instructions to
output second warning information in a case where the actual measurement value becomes lower than a fifth threshold value, and
output the first warning information in a case where the actual measurement value is not lower than the fifth threshold value but the warning condition is satisfied.

9. A warning method executed by a computer, the method comprising:
acquiring prediction information indicating a change in a predicted value of SOC of a vehicle while traveling based on a transport plan is performed;
acquiring an actual measurement value of SOC of the vehicle while traveling based on the transport plan is performed;
determining whether a relationship between the predicted value and the actual measurement value satisfies a predetermined warning condition; and
outputting first warning information in a case where the warning condition is satisfied.

10. A non-transitory storage medium storing a program causing a computer to:
acquire prediction information indicating a change in a predicted value of SOC of a vehicle while traveling based on a transport plan is performed;
acquire an actual measurement value of SOC of the vehicle while traveling based on the transport plan is performed;
determine whether a relationship between the predicted value and the actual measurement value satisfies a predetermined warning condition; and
output first warning information in a case where the warning condition is satisfied.

11. The warning method according to claim 9, wherein
the warning condition includes a matter that the actual measurement value at a moment of departing from a base is less than the predicted value at the moment.

12. The warning method according to claim 9, wherein
the warning condition includes a matter that the actual measurement value at a moment of departing from a base is less than the predicted value at the moment, and a deviation level between the actual measurement value and the predicted value is equal to or more than a first threshold value.

13. The warning method according to claim 9, wherein
the warning condition includes a matter that the actual measurement value at a moment after departing from a base is less than the predicted value at the moment, and a deviation level between the actual measurement value and the predicted value is equal to or more than a second threshold value.

14. The warning method according to claim 9, wherein
the warning condition includes a matter that the actual measurement value at a moment after departing from a base is less than the predicted value at the moment, a deviation level between the actual measurement value and the predicted value is equal to or more than a third threshold value and less than a fourth threshold value, and there is no charging facility at and after a criterion point in a traveling route based on the transport plan.

15. The warning method according to claim 14, wherein
the criterion point is a transport destination in a predetermined visiting order among a plurality of transport destinations, a point where the vehicle is predicted to be located at a criterion time, or a point where the predicted value is predicted to be a criterion value.

16. The non-transitory storage medium according to claim 10, wherein
the warning condition includes a matter that the actual measurement value at a moment of departing from a base is less than the predicted value at the moment.

17. The non-transitory storage medium according to claim 10, wherein
the warning condition includes a matter that the actual measurement value at a moment of departing from a base is less than the predicted value at the moment, and a deviation level between the actual measurement value and the predicted value is equal to or more than a first threshold value.

18. The non-transitory storage medium according to claim 10, wherein
the warning condition includes a matter that the actual measurement value at a moment after departing from a base is less than the predicted value at the moment, and a deviation level between the actual measurement value and the predicted value is equal to or more than a second threshold value.

19. The non-transitory storage medium according to claim 10, wherein
the warning condition includes a matter that the actual measurement value at a moment after departing from a base is less than the predicted value at the moment, a deviation level between the actual measurement value and the predicted value is equal to or more than a third threshold value and less than a fourth threshold value, and there is no charging facility at and after a criterion point in a traveling route based on the transport plan.

20. The non-transitory storage medium according to claim 19, wherein
the criterion point is a transport destination in a predetermined visiting order among a plurality of transport destinations, a point where the vehicle is predicted to be
